(19) United States
(12) Patent Application Publication
(10) Pub. No.: US 2016/0145916 A1
(43) Pub. Date: May 26, 2016

(54) FASTENING DEVICE INTEGRATED WITH ALIGNMENT FEATURE

(71) Applicants: DENSO International America, Inc., Southfield, MI (US); DENSO CORPORATION, Kariya-city (JP)

(72) Inventors: James Link, West Bloomfield, MI (US); Nikolai Akinin, Canton, MI (US)

(21) Appl. No.: 14/554,654

(22) Filed: Nov. 26, 2014

(51) Int. Cl. E05C 19/06

(52) U.S. Cl. CPC E05C 19/06

(57) ABSTRACT

A fastening device for securing a first component to a second component includes a latch coupled with the first component and a catch coupled with the second component. The fastening device further includes a convex portion formed with one of the latch and the catch and a concave portion formed with the other of the latch and the catch. The catch is configured to engage with the latch when the concave portion receives the convex portion.

### TECHNICAL FIELD

The present disclosure relates to a fastening device that secures two components together.

### BACKGROUND

An example of a fastening device is disclosed in U.S. Pat. No. 6,883,874 B2. The fastening device is coupled with a pressure sensor casing that consists of an upper casing and a lower casing. The upper casing and the lower casing of the pressure sensor casing are assembled to contain an electric circuit inside. These casings are secured together with the fastening device that employs a latch and catch mechanism. The lower casing has the latch designed to engage the catch that is formed on the upper casing. Such latch-and-catch engagement is commonly used in assembling parts. However, it is strictly required for workers to ensure a proper alignment in assembling such that the latch engages the catch in a desired position. Otherwise, the engagement is not established or easy to disengage even if once it is established.

For the above reason, another example of such fastening device is presented with an HVAC casing that consists of two halves similar to the previous one. See FIG. 5 of the present disclosure. In addition to the fastening device, an alignment device, which includes a guide pin and a guide hole, is provided adjacent left to the fastening device. The lower casing has the guide hole being capable to receive the guide pin formed on the upper casing to ensure the proper alignment in assembling of the casings. Furthermore, a backup device, which includes a screw and a thread hole, is provided adjacent right to the fastening device. The backup device keeps the two halves of casing secured even if the latch and/or the catch is broken or released. Despite the advantage of the alignment device and the backup device, however, such additional features may cause not only a die complication in designing and a cycle time increasing in manufacturing, but also a spatial restriction of the casing itself.

### SUMMARY

It is an object of the present disclosure to provide a fastening device integrated with an alignment feature that ensures a proper alignment in assembling.

It is therefore an aspect of the present disclosure to provide a fastening device for securing a first component to a second component includes a latch coupled with the first component and a catch coupled with the second component. The fastening device further includes a convex portion formed with one of the latch and the catch and a concave portion formed with the other of the latch and the catch. The catch is configured to engage with the latch when the concave portion receives the convex portion.

### BRIEF DESCRIPTION OF THE DRAWINGS

The above and other objects, features and advantages of the present invention will become more apparent from the following detailed description made with reference to the accompanying drawings. In the drawings:

FIG. 1 is a view showing a fastening device 1;

FIG. 2 is an exploded view showing the fastening device 1;

FIG. 3 is another exploded view showing the fastening device 1;

FIG. 4 is a cross sectional view taken along line A-A of FIG. 1; and

FIG. 5 is a view showing a prior art of a fastening device provided with an aligning feature and a backup feature.

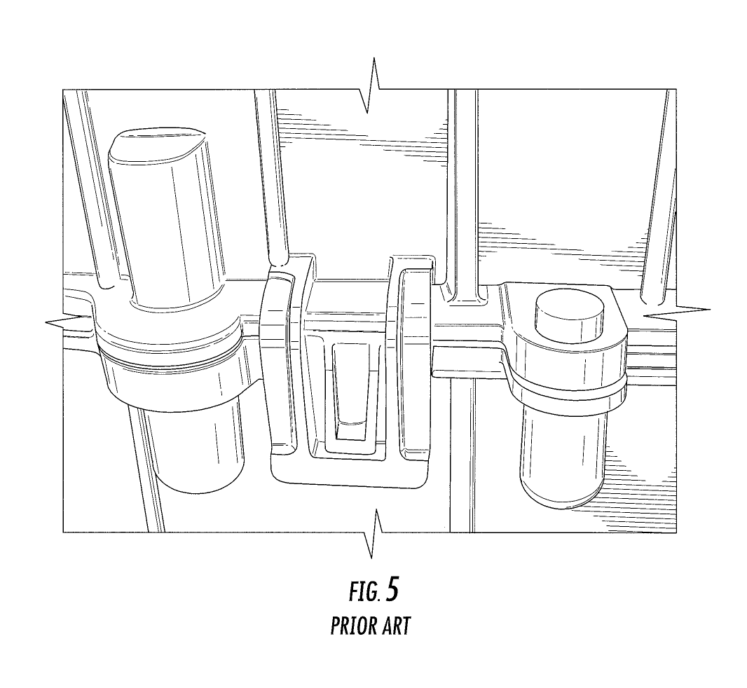

### DETAILED DESCRIPTION

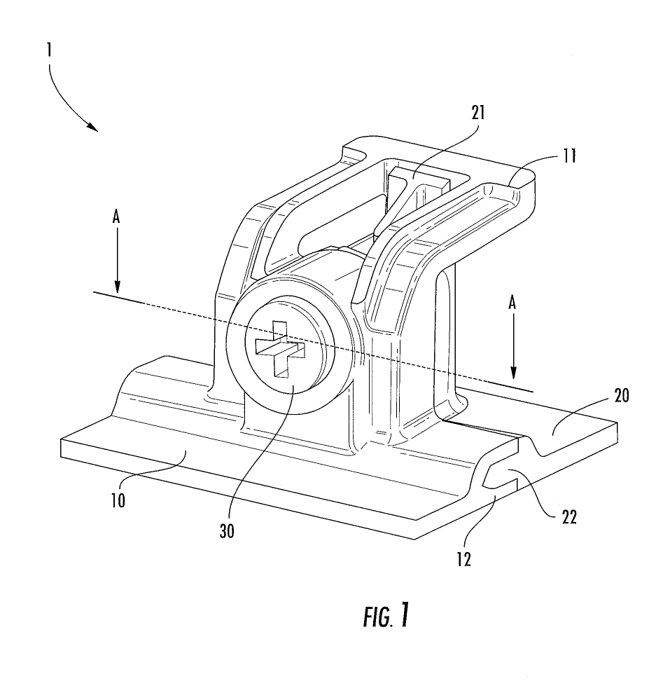

An embodiment of the present disclosure is described referring to the drawings. An outline view of FIG. 1 shows a fastening device 1 including a latch 11 coupled with an upper half 10 of a casing, a catch 21 coupled with a lower half 20 of the casing, and a screw 30 for securing the upper half 10 and the lower half 20 of the casing.

The latch 11 is designed to engage the catch 21 when the upper half 10 and the lower half 20 are assembled into one casing. Once the latch 11 engages the catch 21, combined, they keep the casing secured unless the engagement is intentionally released.

The upper half 10 of the casing has a groove 12 along its opening edge. On the other hand, the lower half 20 of the casing has a lip 22 along its opening edge. The upper half 10 and the lower half 20 of the casing are aligned by fitting the groove 12 and the lip 22 together. The casing seals automotive components, such as HVAC internal components, from the outside environment. The casing is made of resin, for example.

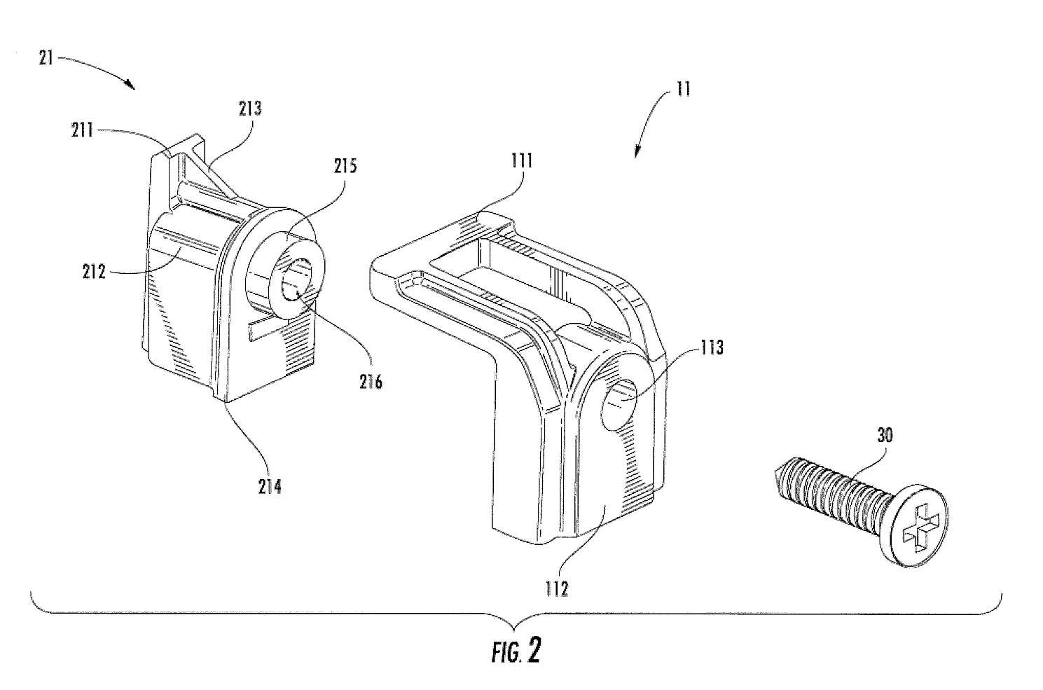

A further structural aspect of the fastening device 1 will be now described more in detail with reference to FIGS. 2 through 4. As shown in FIG. 2, the latch 11 includes a U-shaped clip 111 and a clip base 112. The clip base 112 is also explained as a main body 112 of the latch 11. The U-shaped clip 111 is extended perpendicularly from two opposing sides of the clip base 112 which is integrally molded as a part of the upper half 10 of the casing. The U-shaped clip 111 has elastic property and is slightly bendable outwardly from an original position that makes right angle with the clip base 112. A through hole 113 is formed to penetrate through the clip base 112 in the direction of thickness thereof.

The catch 21 includes a barb 211 and a screw boss 212. The screw boss 212 is also explained as a main body 112 of the catch 21. On a far side from the latch 11, the barb 211 protrudes from an outer surface of the screw boss 212 which is integrally molded as a part of the lower half 20 of the casing. The tip portion of the barb 211 and the outer surface of the screw boss 212 are smoothly bridged over with a slope portion 213. The screw boss 212 has a flange 214 on a near side to the latch 11. A guide pin 215 protrudes towards the latch 11 from the flange 214 with a self-tapping hole 216 formed inside. The self-tapping hole 216 is designed to be slightly undersized to the screw 30. Instead of the self-tapping hole 216, it also may be replaced with a threaded hole that is tapped in advance.

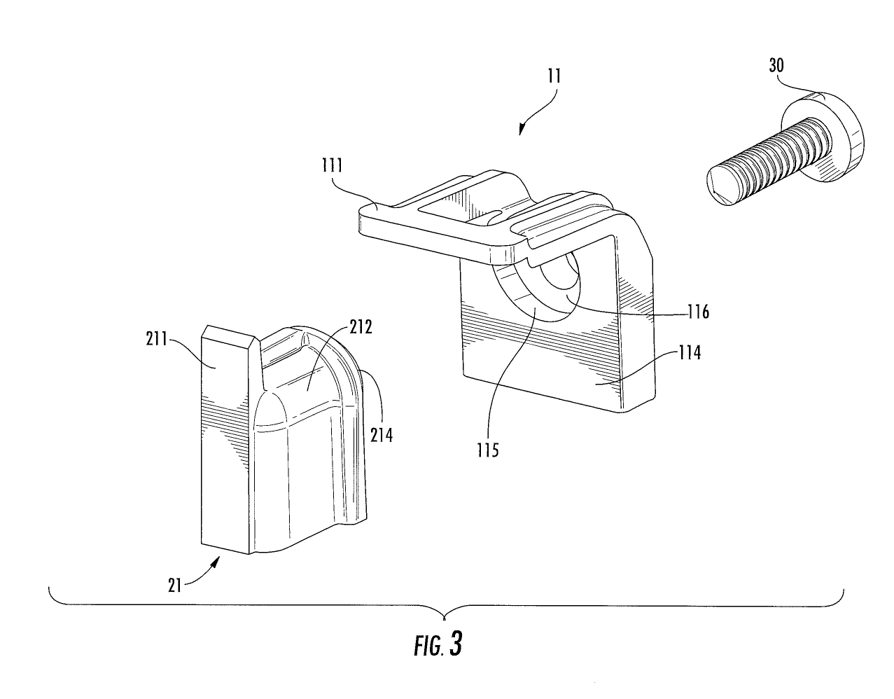

As shown in FIG. 3, the clip base 112 has an inner surface 114 facing to a surface of the flange 214. The inner surface 114 has a guide hole 115 with a bottom portion 116 which has an opening corresponding to an end of the through hole 113. In other words, the through hole 113 and the guide hole 115 constitute a cylindrical hole which has two different diameter inner surface with the bottom portion 116 therebetween.

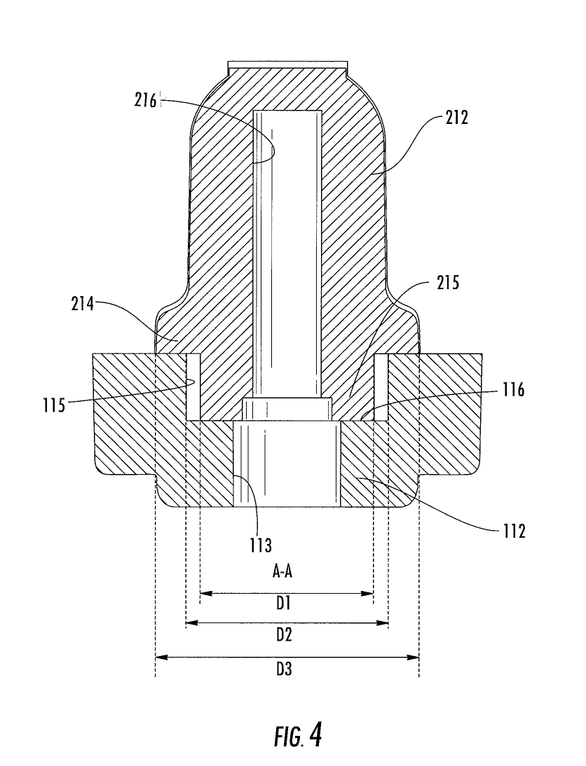

As shown in FIG. 4, the guide pin 215 has an outer diameter D1 substantially equal to or slightly smaller than the inner diameter D2 of the guide hole 115. More specifically, the inner diameter D2 of the guide hole 115 is less than an outer diameter D3 of the flange 214. It make the guide pin 215 possible to be inserted into the guide hole 115 until when the bottom portion 116 substantially contacts with or approaches close to an upper end of the guide pin 215. At the same time, the flange 214 substantially contacts with or approaches close to a surface of the clip base 112.

A fastening process with the use of the fastening device 1 will be now described with reference to FIGS. 1 through 3. Firstly, two openings of the upper half 10 and the lower half 20 of the casing are put together such that the guide pin 215 inserts into the guide hole 115. Secondly, the clip 111 starts to be elastically bent outwardly along the slope portion 213 and eventually gets over the tip portion of the barb 211. The clip 111 returns to an original shape with spring back force inwardly and engages with the barb 211 rigidly. The guide pin 215 and the guide hole 115 ensure a proper engaging alignment of the clip 111 and the barb 211. Thirdly, the screw 30 is inserted through the through hole 113 and screwed into the self-tapping hole 216 to secure the upper half 10 and the lower half 20 of the casing closed. The screw 30 guarantees to keep the casing closed in case the clip 111 and/or the barb 211 is accidently released or broken.

According to above disclosure, the fastening device 1 integrally contains three features as following: a fastening feature performed by the latch 11 and the catch 21; an alignment feature performed by the guide pin 215 and the guide hole 115; and a backup feature performed by the screw 30. This integrated design enables the fastening device 1 to be assembled easier, to be produced cheaper, and to perform durable.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fastening device for securing a first component to a second component comprising:
a latch coupled with the first component;
a catch coupled with the second component;
a convex portion formed with one of the latch and the catch; and
a concave portion formed with the other of the latch and the catch, wherein
the catch is configured to engage with the latch when the concave portion receives the convex portion.

2. The fastening device according to claim 1, wherein the latch and the catch each have main bodies facing to or in contact with each other.

3. The fastening device according to claim 2, wherein a clip extends from the main body of the latch, a barb protrudes outwardly from the main body of the catch.

4. The fastening device according to claim 3, wherein the clip elastically bends in the same direction of the barb protrudes.

5. The fastener device according to claim 1, wherein the convex portion has an upper surface, the concave portion has a bottom surface, such that the upper surface and the bottom surface are facing to or in contact with each other.

6. The fastener device according to claim 1, wherein the convex portion has an outer diameter, the concave portion has an inner diameter, such that the outer diameter is equal to or smaller than the inner diameter.

7. The fastening device according to claim 1, wherein at least one of the convex portion and the concave portion includes a through hole.

8. The fastening device according to claim 8, wherein at least one of the convex portion and the concave portion includes a screw hole, such that a screw is inserted through the through hole and is screwed into the screw hole.

9. The fastening device according to claim 1, wherein one of the convex portion and concave portion includes a through hole, the other of the convex portion and concave portion includes a screw hole, such that a screw is inserted through the through hole and is screwed into the screw hole.
